(19) United States
(12) Patent Application Publication
(10) Pub. No.: US 2018/0195216 A1
(43) Pub. Date: Jul. 12, 2018

(54) MESH FABRIC STRUCTURE AND MESH FABRIC MATERIAL

(71) Applicant: YU SHEN ENTERPRISE INC., Taichung City (TW)

(72) Inventor: Hsueh-Fa LIN, Taichung City (TW)

(21) Appl. No.: 15/866,037

(22) Filed: Jan. 9, 2018

(30) Foreign Application Priority Data
Jan. 12, 2017 (TW) 106101008
Jan. 12, 2017 (TW) 106101010

(51) Int. Cl. D04B 1/12; B32B 23/10; B32B 5/26; B32B 7/02; D06M 17/00; A41D 27/28; B32B 7/12

(52) U.S. Cl. CPC D04B 1/12; B32B 23/10; B32B 5/26; B32B 7/02; B32B 5/026; A41D 27/28; B32B 7/12; B32B 2262/0292; D10B 2401/02; D06M 17/00

(57) ABSTRACT

A mesh fabric structure includes a lower layer of mesh fabric and an upper layer of mesh fabric. Each of the two mesh fabrics has multiple regularly arranged meshes. The upper and lower layers of mesh fabrics are up and down overlapped with each other. The meshes of the two mesh fabrics are up and down arranged corresponding to each other to form regular 2D figures on the mesh fabric structure. A mesh fabric material includes a substrate fabric, a middle layer and a facial fabric, which are overlapped with each other. Each of the substrate fabric and the facial fabric has multiple meshes. The middle layer has at least one hollow section. The meshes of the substrate fabric and the meshes of the facial fabric are arranged corresponding to each other through the hollow section to form a 2D figure in the hollow section.

### BACKGROUND OF THE INVENTION

### 1. Field of the Invention

The present invention relates generally to a fabric material, and more particularly to a mesh fabric material with 2D and/or 3D figures. The mesh fabric material is applicable to shoes, clothes, box bodies, etc. The mesh fabric material is air-permeable and has beautiful appearance.

### 2. Description of the Related Art

The shoe face of a conventional shoe is generally formed with figures or stripes in the form of a plane face. Such figures or stripes are relatively monotonous and lack any specialty. The stripes on the conventional shoe face are formed by means of printing. The printing process will lead to increase of the manufacturing cost. In addition, after a long period of use, the printed stripes tend to damage and peel off from the shoe face. Furthermore, the stripes/figures are mostly partially, not fully printed on the shoe face.

### SUMMARY OF THE INVENTION

It is therefore a primary object of the present invention to provide a mesh fabric structure and a mesh fabric material formed with 2D figures/stripes.

It is a further object of the present invention to provide the above mesh fabric structure and mesh fabric material, on which the 2D figures/stripes are durable.

It is still a further object of the present invention to provide the above mesh fabric structure and mesh fabric material, which can be fully formed with regular figures/stripes.

It is still a further object of the present invention to provide the above mesh fabric structure and mesh fabric material, on which the figures/stripes are formed with the printing cost lowered and with the production efficiency increased.

It is still a further object of the present invention to provide a mesh fabric material, which has solid decorative articles.

The mesh fabric structure of the present invention includes a lower layer of mesh fabric and an upper layer of mesh fabric. The upper layer of mesh fabric has multiple regularly arranged meshes. The lower layer of mesh fabric also has multiple regularly arranged meshes. The upper and lower layers of mesh fabrics are up and down overlapped with each other. The meshes of the two mesh fabrics are up and down arranged corresponding to each other to form regular 2D figures on the mesh fabric structure.

Accordingly, the mesh fabric structure of the present invention can be formed with regular and unified 2D figures/stripes without any printing process.

The mesh fabric material of the present invention includes a substrate fabric, a middle layer and a facial fabric, which are sheet-shaped materials overlapped with each other.

The substrate fabric has multiple meshes. The middle layer has a hollow design. The hollow section is formed with at least one hollow section on the middle layer. The middle layer is disposed on the top face of the substrate fabric.

The facial fabric also has multiple meshes and is disposed on the middle layer.

At least one hot melt adhesive mesh is disposed between the sheet-shaped materials for adhering the sheet-shaped materials to each other.

The meshes of the substrate fabric and the meshes of the facial fabric are arranged corresponding to each other through the hollow section of the design so as to forma 2D figure in the hollow section.

Accordingly, regular 2D figures/stripes are formed on the surface of the mesh fabric material.

Preferably, at least one solid decorative article is disposed on the surface of the fabric material in a bossed form.

Preferably, the decorative article is at least one character or figure made of polymer material.

Preferably, the decorative article is at least one bossed figure/stripe.

Accordingly, the mesh fabric material has both 2D figure and 3D (solid) figure/stripe.

The present invention can be best understood through the following description and accompanying drawings, wherein:

### BRIEF DESCRIPTION OF THE DRAWINGS

FIG. 1 is a view of a first embodiment of the mesh fabric structure of the present invention, showing that two mesh fabrics are up and down overlapped to form a pattern of 2D figure;

FIG. 2 is a view of the first embodiment of the mesh fabric structure of the present invention, showing that the two mesh fabrics are up and down overlapped to form another pattern of 2D figure;

FIG. 3 is a view of the first embodiment of the mesh fabric structure of the present invention, showing that two mesh fabrics are up and down overlapped to form another pattern of 2D figure;

FIG. 4 is a perspective view of a second embodiment of the mesh fabric material of the present invention;

FIG. 5 is a sectional view taken along line 5-5 of FIG. 4;

FIG. 6 is a perspective view of the substrate fabric and the hot melt adhesive mesh of the second embodiment of the present invention;

FIG. 7 is a top view of the middle layer of the second embodiment of the present invention;

FIG. 8 is a sectional view taken along line 8-8 of FIG. 7;

FIG. 9 is a perspective view of the facial fabric and another hot melt adhesive mesh of the second embodiment of the present invention;

FIG. 10 is a partially top view of the mesh fabric material according to FIG. 4, showing a pattern of 2D figure;

FIG. 11 is substantially identical to FIG. 10, showing another pattern of 2D figure of the mesh fabric material of the second embodiment of the present invention;

FIG. 12 is a perspective exploded view of a third embodiment of the mesh fabric material of the present invention;

FIG. 13 is a sectional view of the middle layer of the third embodiment of the present invention;

FIG. 14 is a sectional assembled view of the mesh fabric material according to FIG. 12;

FIG. 15 is a top view of a fourth embodiment of the mesh fabric material of the present invention;

FIG. 16 is a top view showing that a 3D figure is adhered to the mesh fabric material;

FIG. 17 is a side view showing the processing process according to FIG. 16; and

FIG. 18 is a sectional view taken along line 18-18 of FIG. 15.

### DETAILED DESCRIPTION OF THE PREFERRED EMBODIMENTS

The present invention provides a mesh fabric structure formed of two layers of mesh fabric material. The mesh fabric structure and the mesh fabric material provided by the present invention are applicable to various products made of fabric material, such as shoes, clothes or bags. Please refer to FIGS. 1 to 3, which show a first embodiment of the mesh fabric structure 10 of the present invention. The mesh fabric structure 10 is formed with regular 2D figures/stripes. The 2D figures mean two-dimensional figures. As shown in FIGS. 1 to 3, the mesh fabric structure 10 of the present invention is, but not limited to, formed with regular figures with different patterns.

The mesh fabric structure 10 is formed of two sheets of mesh fabrics 20, 22, which are overlapped with each other. For easy illustration, the mesh fabric 20 is a lower layer of mesh fabric, while the mesh fabric 22 is an upper layer of mesh fabric. The upper and lower layers are simply defined according to their relative positions.

Please refer to FIG. 1. The mesh fabrics 20, 22 are fabric materials made by means of weaving. The mesh fabrics 20, 22 have threads arranged in two directions, which are respectively a first thread 23 positioned in a first direction and a second thread 24 positioned in a second direction. The threads 23, 24 intersect each other to define therebetween multiple regularly arranged meshes 25. The diameter of the mesh 25 is larger than the diameter of the threads 23, 24, whereby the light beam can easily pass through the mesh fabrics.

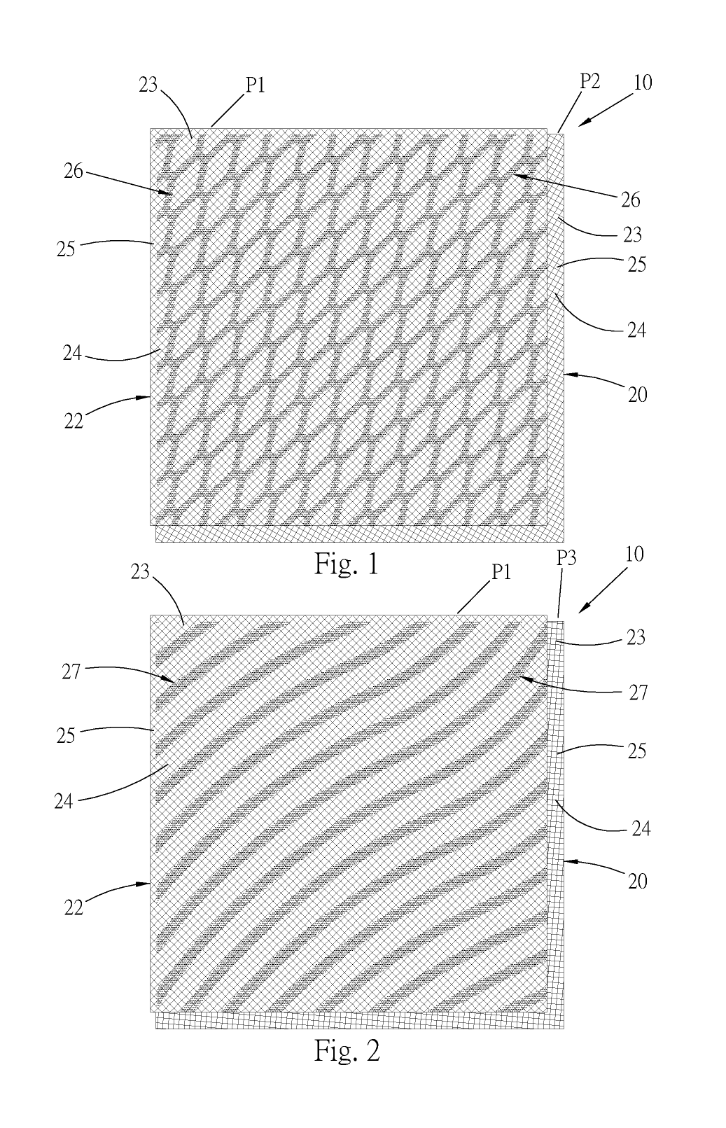

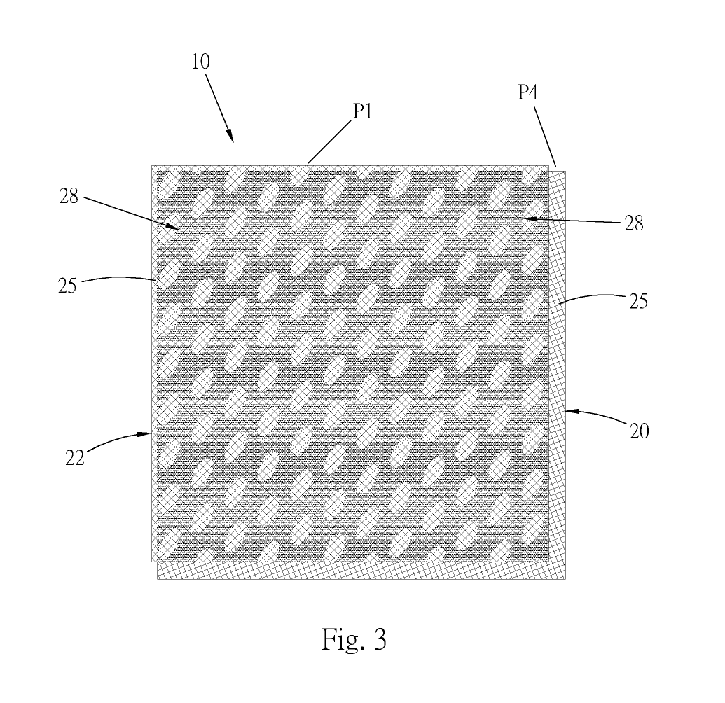

As shown in FIG. 1, the two mesh fabrics 20, 22 are overlapped with each other to form the 2D figures/stripes. As shown in the drawing, the first thread 23 of the upper layer of mesh fabric 22 is positioned in the direction P1, while the first thread 23 of the lower layer of mesh fabric 20 is positioned in the direction P2. The direction P1 of the first thread 23 of the mesh fabric 22 is not parallel to the direction P2 of the first thread 23 of the mesh fabric 20 and the directions P1, P2 contain an angle. The directions of the first threads 23 of the two mesh fabrics are not in parallel to each other so that the second threads of the two mesh fabrics 20, 22 also are not in parallel to each other. When the meshes 25 of the two mesh fabrics 20, 22 are up and down arranged, the voids of the corresponding meshes 25 of the upper and lower layers of mesh fabrics will form a sparse/dense state. That is, in some positions, the voids of the meshes are denser, while in some other positions, the voids of the meshes are sparser. The light beam penetrates and scatters between the meshes 25 of the upper and lower layers of mesh fabrics 20, 22 to form a pattern of 2D FIG. 26 on the two mesh fabrics. The 2D FIG. 26 is regularly distributed over the mesh fabric structure 10. When the two mesh fabrics 20, 22 are overlapped by another angle, as shown in FIG. 2, the first thread 23 of the upper layer of mesh fabric 22 is positioned in the direction P1, while the first thread 23 of the lower layer of mesh fabric 20 is positioned in the direction P3. The angle contained between the directions P1 and P3 is different from the angle contained between the directions P1 and P2 as shown in FIG. 1. Under such circumstance, the meshes 25 of the upper layer of mesh fabric 22 and the lower layer of mesh fabric 20 are arranged to form voids in another sparse/dense relationship so as to form another pattern of 2D FIG. 27 regularly presented on the mesh fabric structure 10. Please refer to FIG. 3. when the two mesh fabrics 20, 22 are up and down overlapped by still another angle, for example, the first thread 23 of the upper layer of mesh fabric 22 is positioned in the direction P1, while the first thread 23 of the lower layer of mesh fabric 20 is positioned in the direction P4, the sparse/dense relationship of the voids formed by the meshes 25 of the mesh fabrics 20, 22 will form another pattern of 2D FIG. 28 regularly presented on the mesh fabric structure 10.

Accordingly, the corresponding meshes 25 of the two layers of mesh fabrics 20, 22 can form regular 2D figures/stripes, which are fully presented on the mesh fabric structure 10. When the two mesh fabrics 20, 22 are overlapped by different angles, different patterns of 2D figures are presented on the mesh fabric structure 10.

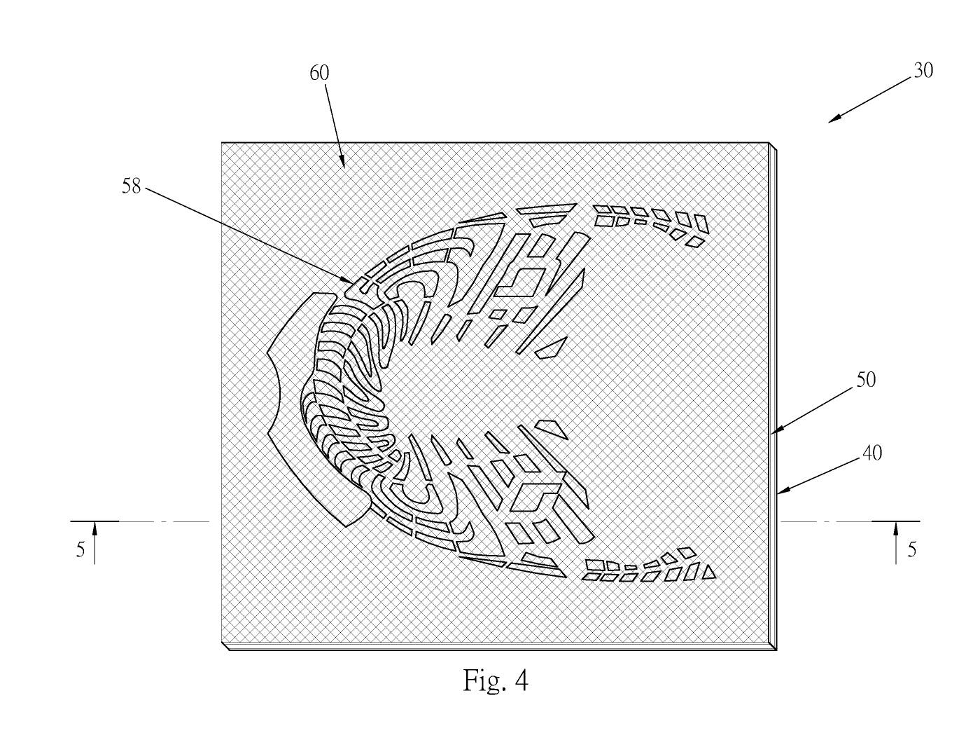

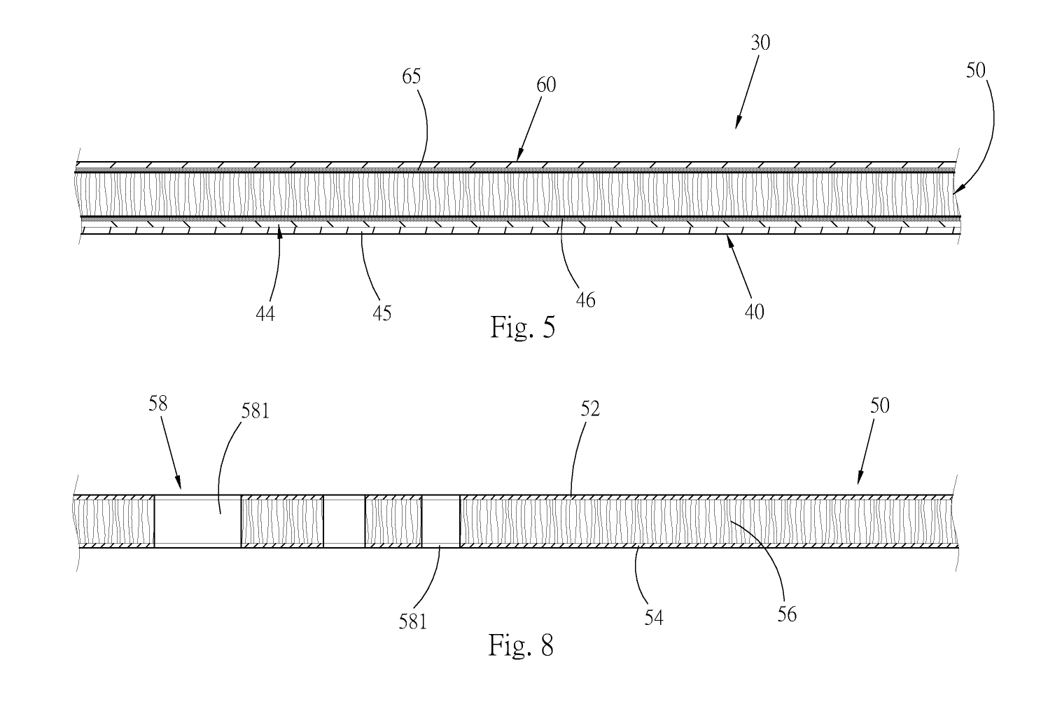

FIGS. 4 and 5 show a second embodiment of the mesh fabric material 30 of the present invention. The mesh fabric material 30 is made of the aforesaid mesh fabric structure (two layers of mesh fabrics).

The mesh fabric material 30 is a product with a multilayered structure. The mesh fabric material 30 includes a substrate fabric 40, a middle layer 50 and a facial fabric.

Please refer to FIG. 5. The substrate fabric 40 is a lining of the fabric material 30. Multiple meshes 42 are regularly disposed on a top face of the substrate fabric 40. The structure of the mesh 42 is identical to that of the mesh 25 of the first embodiment. To speak more specifically, the substrate fabric 40 has a lining layer 45 and a mesh fabric 44 adhered onto the lining layer 45. The mesh fabric 44 is the lower layer of mesh fabric 20 as described in the first embodiment. The mesh fabric 44 has multiple first threads 441 positioned in a first direction and multiple second threads 442 positioned in a second direction and the meshes 42. In this embodiment, the lining layer 45 is preferably a fabric made of natural fiber or chemical fiber. The fabric is selected from a group consisting of fabric with moisture absorption effect, antibacterial fabric with bamboo charcoal material, thermal (fluffy) fabric and material with light reflection effect. The lining layer 45 can be printed or not printed. The lining layer 45 can be monocolored or colorful or with gradient color. The mesh fabric 44 and the lining layer 45 are combined into the substrate fabric 40. It should be noted that in practice, the substrate fabric 40 can be solely formed of the mesh fabric 44.

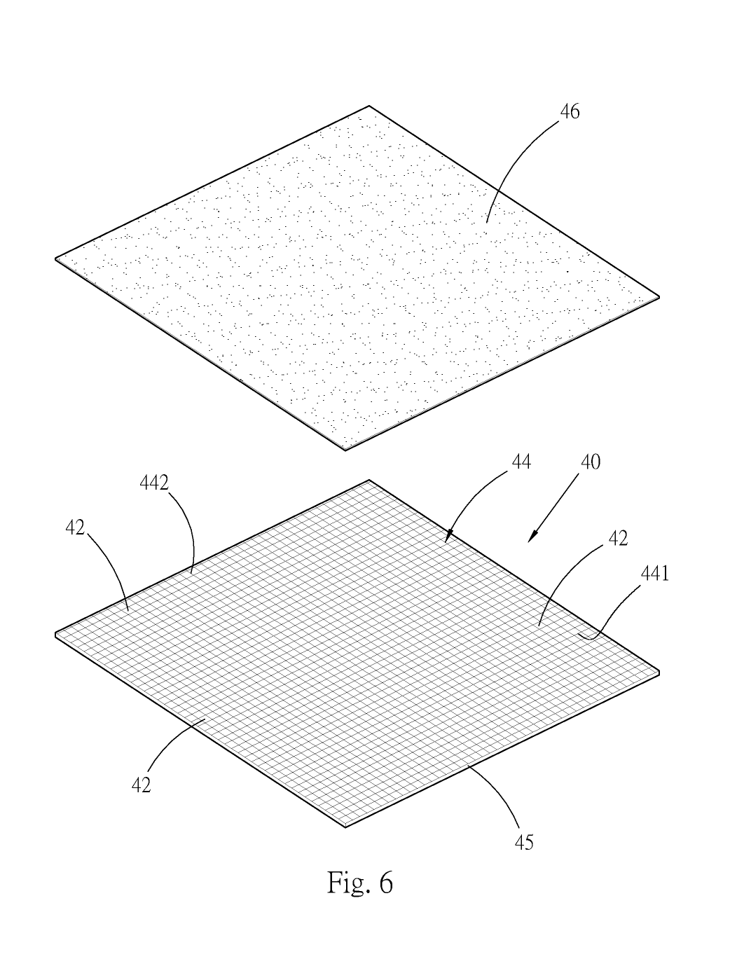

The substrate fabric 40 is a sheet of fabric material cut into a rectangular shape. Please refer to FIG. 6. A hot melt adhesive mesh 46 is disposed on a top face of the substrate fabric 40, that is, disposed on the mesh fabric 44.

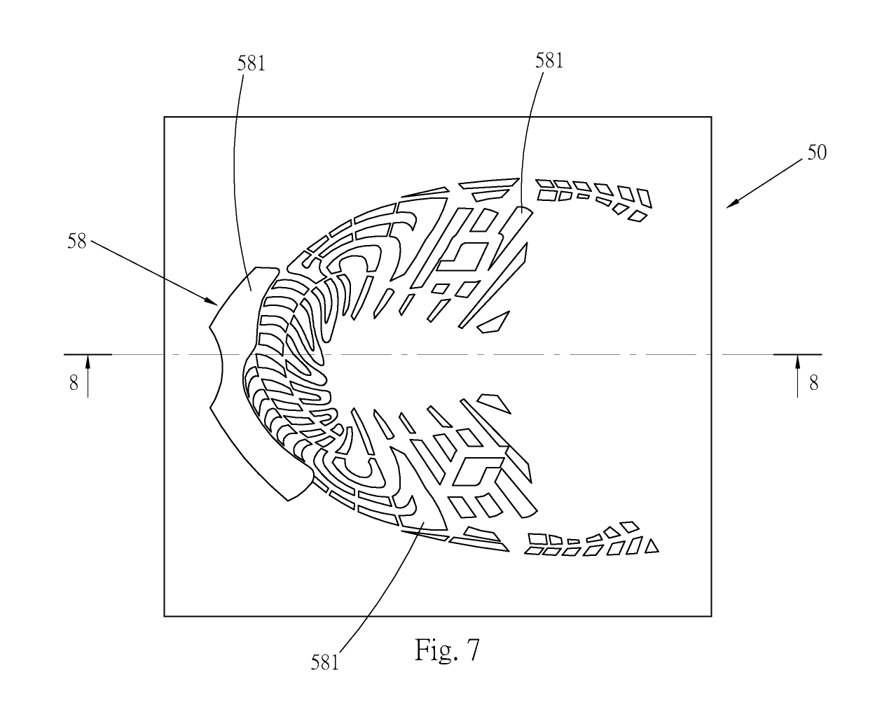

Please refer to FIGS. 7 and 8. In this embodiment, the middle layer 50 is a fabric with three-layer structure. The middle layer 50 is soft, elastic and air-permeable. For example, the middle layer 50 can be a sandwich mesh fabric (or so-called air mesh fabric) formed by means of knitting or weaving. The middle layer 50 has two facial layer sections 52, 54 and an inner layer section 56 positioned between the facial layer sections 52, 54. The two facial layer sections 52, 54 are more tightly woven, while the weaving density of the inner layer section 56 is sparser so that the inner layer section 56 is elastic. The middle layer 50 has good air-permeability. A hollow design 58 is disposed on the middle layer 50. The hollow design 58 is formed by means of laser cutting. In this embodiment, the design 58 is formed with multiple hollow sections 581.

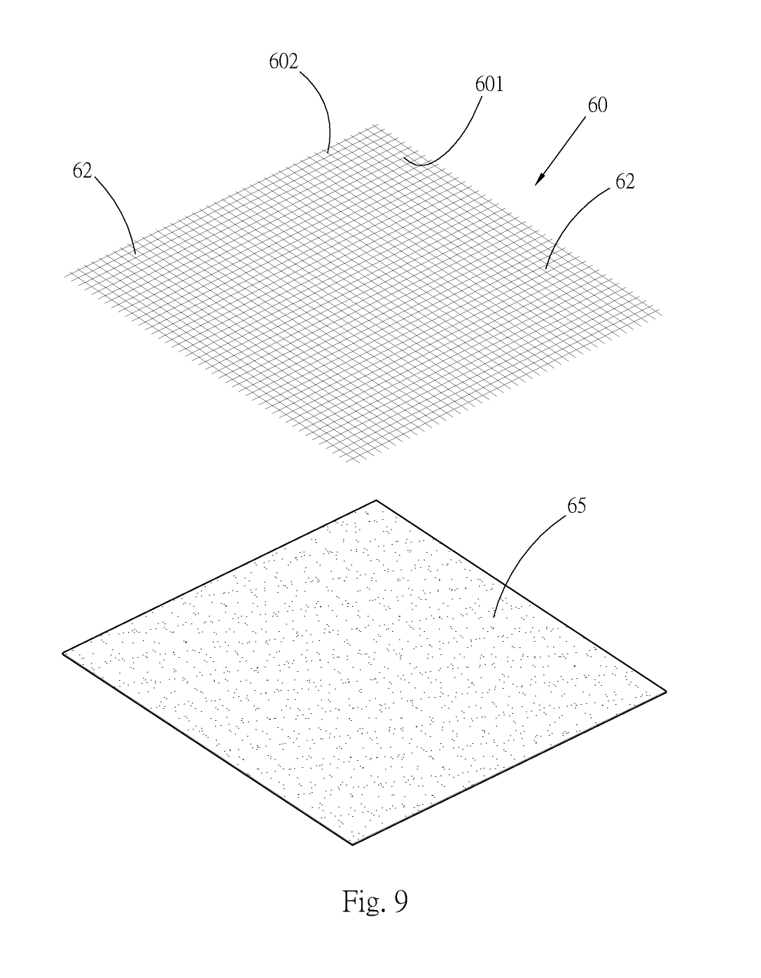

Please refer to FIG. 9. The facial fabric at least includes an upper layer of mesh fabric 60. The mesh fabric 60 is identical to the upper layer of mesh fabric 22 of the first embodiment. The mesh fabric 60 has meshes 62 and multiple first threads 601 and multiple second threads 602. The structure of the meshes 62 is identical to that of the meshes 25 of the first embodiment. The meshes 62 of the facial fabric 60 can have a size equal to or unequal to the size of the meshes 42 of the aforesaid mesh fabric 44. In practice, the color of the upper layer of mesh fabric 60 is preferably different from the color of the lower layer of mesh fabric 44 so as to enhance the contrast and the definition of the 2D figures of the fabric material 30 and highlight the effect.

A second hot melt adhesive mesh 65 is paved between the facial fabric (the upper layer of mesh fabric 60) and the middle layer 50.

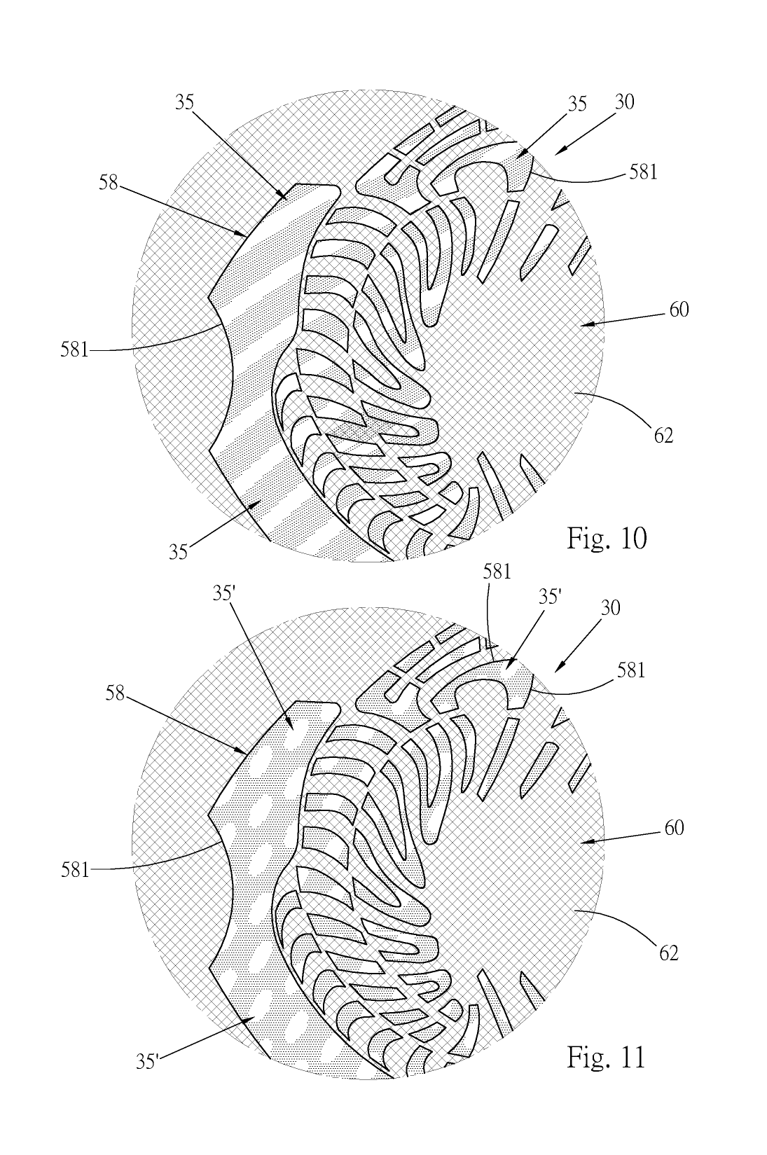

In this embodiment, the mesh fabric material 30 is a multilayered fabric material composed of the aforesaid substrate fabric 40, the middle layer 50, the facial fabric and the two hot melt adhesive meshes 46, 65 bonded with each other. As shown in FIG. 5, the substrate fabric, the middle layer, the facial fabric and the two hot melt adhesive meshes are cut sheet materials, which are up and down overlapped with each other. The middle layer 50 is overlaid on the substrate fabric 40. The facial fabric is overlaid on the middle layer 50. The hot melt adhesive mesh 46 is positioned between the substrate fabric 40 and the middle layer 50. The second hot melt adhesive mesh 65 is positioned between the middle layer 50 and the facial fabric. The sheet materials are thermally pressed (pressurized at high temperature), whereby the two hot melt adhesive meshes 46, 65 are heated and molten into transparent adhesive for adhering the substrate fabric 40, the middle layer 50 and the facial fabric to each other so as to form the fabric material 30. In the position of the hollow design 58 of the middle layer 50, the facial fabric (the upper layer of mesh fabric 60) and the mesh fabric 44 are not shaded. Therefore, through the hollow sections 581 of the design 58, the upper layer of meshes 62 of the facial fabric is correspondingly overlaid on the lower layer of meshes 42 of the mesh fabric 44 in the form of an upper layer and a lower layer. In the hollow sections 581 of the design 58 of the fabric material 30, multiple 2D figures/stripes 35 are formed as shown in FIGS. 10 and 11. The figures/stripes 35, 35′ shown in FIGS. 10 and 11 are different figures formed by the upper layer of mesh fabric 60 and the lower layer of mesh fabric 44 when containing different angles. In this embodiment, only the 2D figures of the fabric material 30 are shown in FIGS. 10 and 11.

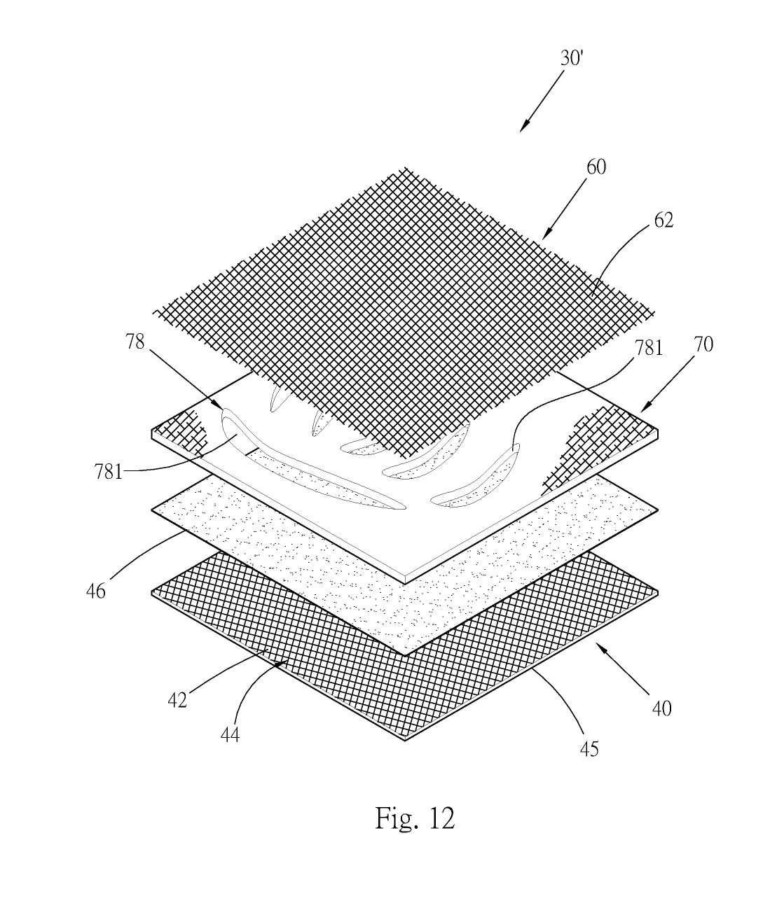

FIGS. 12 to 14 show a third embodiment of the mesh fabric material 30′ of the present invention. The same components are denoted with the same reference numerals. In this embodiment, the mesh fabric material 30′ also includes a substrate fabric 40, a middle layer 70 and a facial fabric (the upper layer of mesh fabric 60). The substrate fabric 40 and the facial fabric can have the same structure as in the second embodiment. The substrate fabric 40 also preferably has a lining layer 45 and a mesh fabric 44. The mesh fabric 44 has regular meshes 42. The facial fabric 60 also has regular meshes 62. The substrate fabric and the facial fabric will not be redundantly described hereinafter.

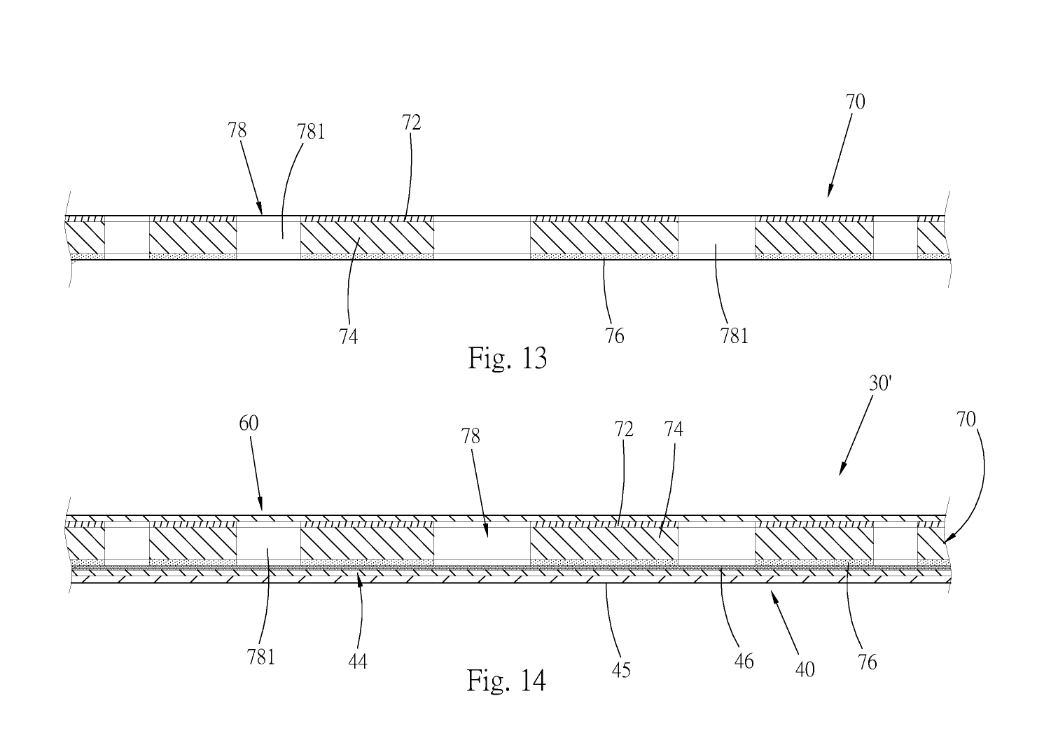

Please refer to FIG. 13. In this embodiment, the middle layer 70 is also a multilayered structure, including a fabric layer 72, a soft layer (a foamed layer 74) and a second hot melt adhesive mesh 76. The fabric layer 72 is bonded with a surface (top face) of the foamed layer 74. The surface of the fabric layer 72 is printable. In this embodiment, the foamed layer 74 is foamed rubber such as styrene block copolymer (SBC). The second hot melt adhesive mesh 76 is attached to the other surface (bottom face) of the foamed layer 74. Thereafter, a hollow design 78 is formed by laser cutting. The design 78 penetrates through the fabric layer 72, the foamed layer 74 and the hot melt adhesive mesh 76.

Please refer to FIG. 14. The cut substrate fabric 40, a hot melt adhesive mesh 46, the middle layer 70 and the facial fabric (the lower layer of mesh fabric 60) are sequentially upward stacked and overlaid on each other and then thermally pressed (pressurized at high temperature), whereby the two hot melt adhesive meshes 46, 76 are heated and molten into adhesive for adhering the substrate fabric 40, the middle layer 70 and the facial fabric (the upper layer of mesh fabric 60) to each other so as to form the fabric material 30′. The adhesive formed by the molten hot melt adhesive meshes 46, 76 will adhere the substrate fabric 40 and the middle layer 70 to each other. In addition, the adhesive will flow through the hollow sections 781 of the design 78 to adhere the facial fabric 40 and the middle layer 70 to each other.

The fabric material 30′ of this embodiment is identical to the fabric material of the second embodiment. The upper layer of meshes 62 and the lower layer of meshes 42 are arranged to form voids in a sparse/dense relationship so as to form a 2D figure on the surface of the fabric material.

It should be noted that the middle layer 50 of the second embodiment can serve as the middle layer of this embodiment. In addition, a second hot melt adhesive mesh can be previously attached to the bottom face of the middle layer 50 and the middle layer 50 can be cut with the necessary hollow design by means of laser.

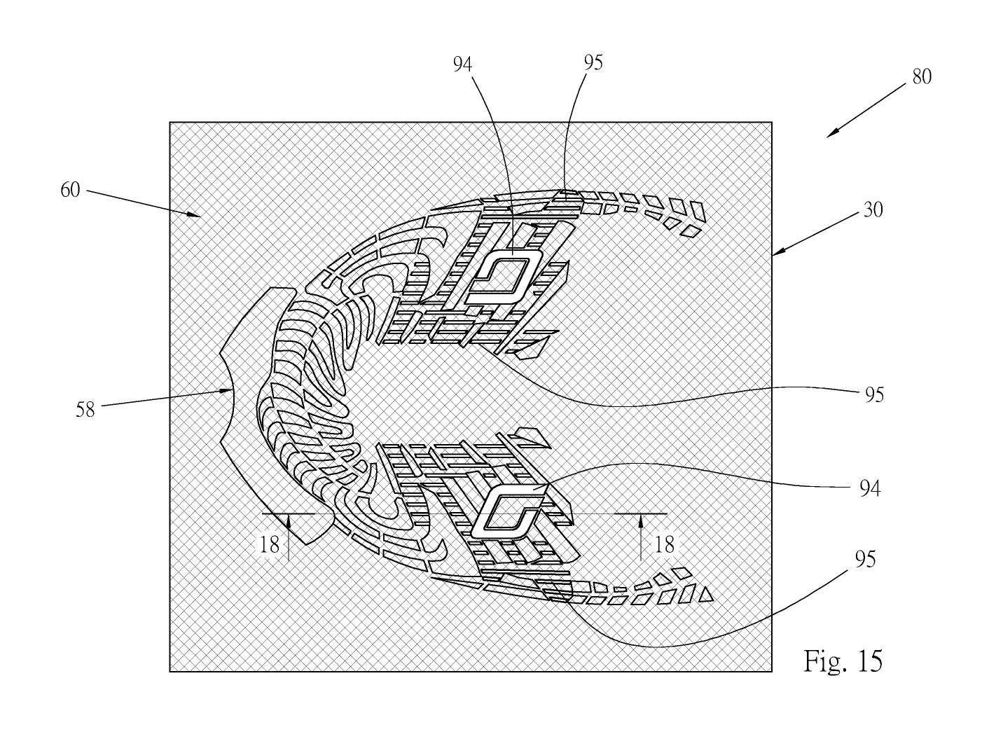

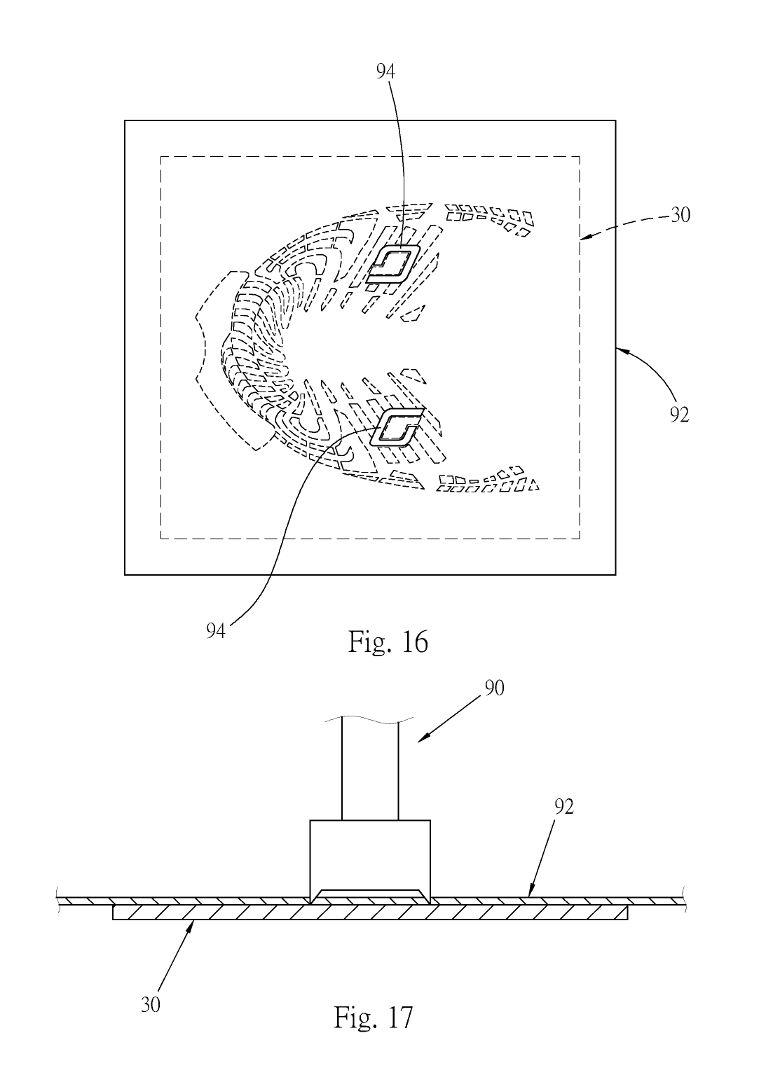

FIG. 15 is a top view of a fourth embodiment of the mesh fabric material 80 of the present invention. In this embodiment, a 3D (three-dimensional) figure is further disposed on the mesh fabric material 30 of the second embodiment (or the third embodiment), including a logo 94 with a certain thickness and a solid figure/stripe 95. The mesh fabric material 30 will not be redundantly described hereinafter. Please refer to FIGS. 16 and 17. A specific character or figure is adhered to the surface of the fabric body 30. With a logo (trademark or label) taken as an example, a sheet-shaped polymer material 92 is placed on the fabric body 30. Then, a machine 90 is used to thermally cut the sheet of polymer material 92 into the configuration of the logo 94 at a certain temperature. Then, the logo 94 is adhered to the outer surface of the fabric body in a specific position by means of high-frequency wave. In this embodiment, the polymer material 92 is thermoplastic polyurethane (TPU). The character or figure is securely adhered onto the fabric body 30 without easy detachment.

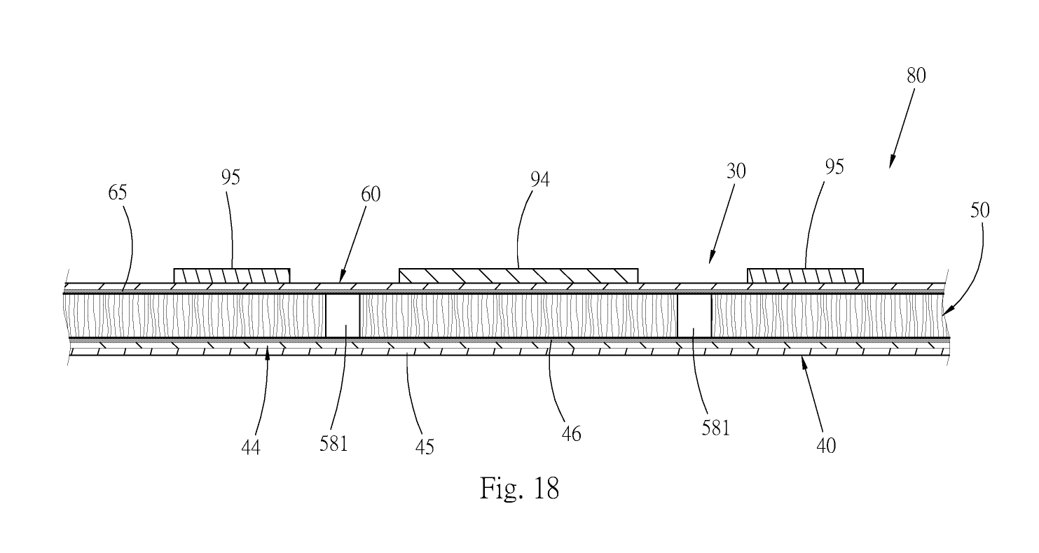

As shown in FIGS. 15 and 18, a 3D figure/stripe 95 is also disposed on the surface of the fabric body 30. The composition of the figure/stripe 95 is a mixture of a dye and glue (adhesive). The figure/stripe 95 is adhesive and can be dyed into different colors. The figure/stripe 95 is printed on the fabric body 30 by means of screen printing. The dye and glue mixture is printed on the fabric body 30 many times. That is, each figure/stripe 95 is formed of multiple layers of the dye and glue mixture to achieve a 3D solid feeling. In this embodiment, the figure/stripe 95 is, but not limited to, straight stripe. In practice, the figure/stripe 95 can have different forms. The aforesaid 2D FIG. 35 or 35′ is presented on the surface of the mesh fabric material 80 of this embodiment. The character or figure (logo 94) and the 3D figure/stripe 95 disposed on the surface of the fabric body are also presented on the surface of the mesh fabric material 80. The 2D figures/stripes 26, 27, 28, 35 and 35′ on the mesh fabric structure or mesh fabric material of the present invention have unity and regularity without unevenness. The product made of the mesh fabric structure can present unique and beautiful figures.

The 2D figures/stripes of the present invention are formed by the meshes of the upper and lower layers of mesh fabrics without printing process. Therefore, the 2D figures/stripes are free from the problems of damage or peeling and the lifetime of the 2D figures/stripes is prolonged.

In the present invention, the substrate fabric (the lower layer of mesh fabric), the middle layer, the facial fabric (the upper layer of mesh fabric) and the hot melt adhesive meshes are previously cut into sheets. The sheets of fabric materials are up and down overlapped and then pressurized and heated, whereby the fabric materials are adhered to each other by means of the hot melt adhesive. Therefore, in the manufacturing process, the respective parts of the mesh fabrics are free from the problem of non-uniform tension and the meshes of the mesh fabrics can keep having the same shape without deformation. Accordingly, the 2D figures everywhere on the mesh fabric structure or mesh fabric material are unified. Moreover, the 2D figures are fully regularly presented on the mesh fabric structure or mesh fabric material.

The 2D figures/stripes are not formed by means of printing so that the equipment for printing the figures/stripes is saved and the manufacturing cost is lowered. Also, the manufacturing process is simplified.

In the case that the upper layer of mesh fabric has a color different from the color of the lower layer of mesh fabric, the inner side of the 2D figures/stripes will have a color different from the color of the outer side of the 2D figures/stripes. Accordingly, the 2D figures/stripes will provide a gradient feeling and present 3D visual effect. In addition, in the case that the sizes of the meshes of the two mesh fabrics are equal to each other or unequal to each other, the patterns of the 2D figures/stripes will be varied.

The mesh fabric material of the present invention breaks through the conventional technique of flat printing to make the mesh fabric material have 2D figures different from the conventional stripes.

In addition to the 2D figures, the surface of the mesh fabric material of the present invention is also formed with bossed characters or figures (such as the logo 94) and 3D figures/stripes 95 so as to present a visual effect different from the conventional fabric material. The characters or figures (the logo) and the figures/stripes are all disposed on the surface of the fabric material 10 in a bossed form so as to provide a solid feeling as a solid decorative article.

The above embodiments are only used to illustrate the present invention, not intended to limit the scope thereof. Many modifications of the above embodiments can be made without departing from the spirit of the present invention.

What is claimed is:

1. A mesh fabric structure comprising two mesh fabrics up and down overlapped with each other, the two mesh fabrics being a lower layer of mesh fabric and an upper layer of mesh fabric, wherein:
the upper layer of mesh fabric has multiple regularly arranged meshes;
the lower layer of mesh fabric has multiple regularly arranged meshes, and
the upper layer of mesh fabric and the lower layer of mesh fabric being up and down overlapped with each other, the meshes of the two mesh fabrics being up and down arranged corresponding to each other to form regular 2D figures on the mesh fabric structure.

2. The mesh fabric structure as claimed in claim 1, wherein each mesh fabric has threads arranged in different directions, the threads having a diameter smaller than a diameter of the meshes.

3. The mesh fabric structure as claimed in claim 1, wherein each mesh fabric has threads arranged in two directions, that is, first threads arranged in a first direction and second threads arranged in a second direction, the first threads of the upper layer of mesh fabric and the lower layer of mesh fabric being unparallel to each other.

4. The mesh fabric structure as claimed in claim 2, wherein each mesh fabric has threads arranged in two directions, that is, first threads arranged in a first direction and second threads arranged in a second direction, the first threads of the upper layer of mesh fabric and the lower layer of mesh fabric being unparallel to each other.

5. The mesh fabric structure as claimed in claim 3, wherein a different pattern of 2D figures is formed when the first threads of the upper layer of mesh fabric and the first threads of the lower layer of mesh fabric being contained a different angle.

6. The mesh fabric structure as claimed in claim 1, wherein the sizes of the meshes of the upper layer of mesh fabric and the lower layer of mesh fabric are equal to or unequal to each other.

7. The mesh fabric structure as claimed in claim 1, wherein the upper layer of mesh fabric and the lower layer of mesh fabric have different colors.

8. A mesh fabric material comprising:
a substrate fabric, a middle layer and a facial fabric, which are sheet-shaped materials overlapped with each other, wherein:
the substrate fabric has multiple regularly arranged meshes;
a hollow design is disposed on the middle layer, the design being formed with one or more than one hollow sections on the middle layer; the middle layer being disposed on a top face of the substrate fabric;
the facial fabric being disposed on the middle layer and having multiple regularly arranged meshes;
at least one hot melt adhesive mesh being disposed between the sheet-shaped materials for adhering the sheet-shaped materials to each other; and
the meshes of the substrate fabric and the meshes of the facial fabric being arranged corresponding to each other through the hollow sections of the design so as to form the 2D figure in the hollow sections.

9. The mesh fabric material as claimed in claim 8, wherein the substrate fabric at least includes a lower layer of mesh fabric, the meshes of the substrate fabric being formed on the lower layer of mesh fabric, the facial fabric at least including an upper layer of mesh fabric, the meshes of the facial fabric being formed on the upper layer of mesh fabric.

10. The mesh fabric material as claimed in claim 9, wherein the substrate fabric further includes a lining layer, the lower layer of mesh fabric being disposed on the lining layer.

11. The mesh fabric material as claimed in claim 9, wherein each mesh fabric has threads arranged indifferent directions, the threads having a diameter smaller than a diameter of the meshes.

12. The mesh fabric material as claimed in claim 9, wherein each mesh fabric has threads arranged in two directions, that is, first threads arranged in a first direction and second threads arranged in a second direction, the first threads of the upper layer of mesh fabric and the lower layer of mesh fabric being unparallel to each other.

13. The mesh fabric material as claimed in claim 12, wherein a different pattern of 2D figures is formed when the first threads of the upper layer of mesh fabric and the first threads of the lower layer of mesh fabric being contained a different angle.

14. The mesh fabric material as claimed in claim 9, wherein the sizes of the meshes of the upper layer of mesh fabric and the lower layer of mesh fabric are equal to or unequal to each other.

15. The mesh fabric material as claimed in claim 9, wherein the upper layer of mesh fabric and the lower layer of mesh fabric have different colors.

16. The mesh fabric material as claimed in claim 8, comprises a hot melt adhesive mesh and a second hot melt adhesive mesh, the hot melt adhesive mesh being positioned between the substrate fabric and the middle layer; the second hot melt adhesive mesh being positioned between the middle layer and the facial fabric.

17. The mesh fabric material as claimed in claim 8, comprises at least one solid decorative article being disposed on a surface of the fabric material, the decorative article being raised from the surface of the fabric material.

18. The mesh fabric material as claimed in claim 17, wherein the solid decorative article is at least one character or figure, the character or the figure being polymer material adhered to the surface of the fabric material and raised from the surface of the fabric material and/or at least one raised figure/stripe.

19. The mesh fabric material as claimed in claim 18, wherein the character or the figure is adhered to the fabric material by means of high-frequency wave, the material of the figures/stripes being a mixture of dye and glue.
